(19) United States
(12) Patent Application Publication
(10) Pub. No.: US 2026/0280919 A1
(43) Pub. Date: Sep. 17, 2026

(54) VIDEO CONFERENCING SYSTEM, AND METHOD AND APPARATUS FOR AUTOMATICALLY RESTORING LINKAGE FOR DEVICE THEREOF

(71) Applicant: YEALINK (XIAMEN) NETWORK TECHNOLOGY CO., LTD., Xiamen, Fujian (CN)

(72) Inventor: Zhiqiang Liao, Xiamen, Fujian (CN)

(21) Appl. No.: 18/716,518

(22) PCT Filed: May 10, 2024
(86) PCT No.: PCT/CN2024/092192

§ 371 Date: Jun. 5, 2024

(30) Foreign Application Priority Data
May 29, 2023 (CN) 202310617603.5

(51) Int. Cl. H04L 12/18; H04L 61/103; H04L 69/163; H04L 101/622

(52) U.S. Cl. CPC H04L 12/1827; H04L 61/103; H04L 69/163; H04L 2101/622

(57) ABSTRACT

The present application discloses a video conferencing system, and a method and an apparatus for automatically restoring linkage for a device thereof. In the method, after a video conferencing accessory loses connection with a video conferencing host, it searches for broadcast messages through BLE, parses relevant network information of host, and compares a parsed MAC address with a MAC address of the original host saved in the accessory. If they are the same, the accessory checks its current network topology. If it's direct wired connection or LAN connection, a TCP connection can be directly established between them; if it's AP connection, the accessory needs to connect to the hot spot of the host before establishing the TCP connection between them, thereby restoring the linkage between them. The present application enables the automatic and rapid restoration of a paired connection without manual intervention when the host and accessory lose connection.

### FIELD OF THE INVENTION

The present application relates to the field of video conferencing technology, particularly to a video conferencing system, and a method and an apparatus for automatically restoring linkage for a device of the video conferencing system.

### BACKGROUND OF THE INVENTION

A video conferencing system includes a video conferencing host and a video conferencing accessory. Common video conferencing accessories include conference control tablets, network cameras, and others. The video conferencing accessory and the video conferencing host need to establish a paired connection relationship between them to enable normal linkage and collaboration. The video conferencing accessory communicates with the video conferencing host through a wired or wireless network. For the host device and accessory that have established the paired connection, changes in the network topology between them often result in a disruption of network communication between them. In such case, it is necessary to re-establish the paired connection to resume normal linkage and collaboration.

Currently, when the video conferencing host and accessory lose connection after a successful pairing, re-establishing the paired connection is typically achieved through manual intervention. Due to changes in the device's IP address, operations such as entering the new IP address through the interface are necessary for re-establishing the pairing. This method requires user manual intervention, resulting in a suboptimal user experience.

### SUMMARY OF THE INVENTION

The present application provides a video conferencing system, and a method and an apparatus for automatically restoring linkage for a device of the video conferencing system. The present application enables automatic and rapid restoration of a paired connection without manual intervention when a video conferencing host and a video conferencing accessory lose connection, thereby enhancing user experience.

To address the above-mentioned technical issue, a first aspect of the present application provides a method for automatically restoring linkage for a video conferencing system device, wherein the method includes:
initiating a search for a broadcast message through BLE (Bluetooth Low Energy) after losing connection with an original video conferencing host;
parsing an IP (Internet Protocol) address, a MAC (Media Access Control) address, and an AP (Access Point) configuration of a video conferencing host when network information of the video conferencing host is identified in a broadcast message;
determining the video conferencing host as the original video conferencing host when the parsed MAC address is the same as a saved MAC address of the original video conferencing host;
sending a TCP (Transmission Control Protocol) network connection request to the video conferencing host according to the parsed IP address of the video conferencing host;
restoring linkage with the original video conferencing host when the video conferencing host accepts the TCP network connection request of a video conferencing accessory.

In the present application, after losing connection with the video conferencing host, the video conferencing accessory can initiate the search for broadcast messages through BLE, parses the relevant network information of the video conferencing host when the network information of the video conferencing host is identified in a broadcast message, and then compares the parsed MAC address with the MAC address of the original video conferencing host saved in the video conferencing accessory. If they are the same, the video conferencing accessory determines the video conferencing host as the original video conferencing host and establish a TCP connection with the video conferencing host according to the parsed IP address of the video conferencing host, thereby restoring their linkage. This achieves the goal of automatic restoration of pairing between devices without manual intervention.

Furthermore, the process of sending a TCP network connection request to the video conferencing host according to the parsed IP address of the video conferencing host specifically includes:
checking a current network topology;
if the current network topology is a direct wired connection or a local area network connection, sending a TCP network connection request to the video conferencing host according to the parsed IP address of the video conferencing host;
if the current network topology is an AP connection, automatically connecting to a hot spot of the video conferencing host according to the parsed AP configuration of the video conferencing host, receiving a network from the video conferencing host, and sending a TCP network connection request to the video conferencing host according to the parsed IP address of the video conferencing host.

In the present application, when the network information of the original video conferencing host is identified, the video conferencing accessory needs to check the current network topology of the video conferencing accessory. If it is a direct wired connection or a local area network connection, the video conferencing accessory can directly establish the TCP network connection between them according to the parsed IP address of the video conferencing host. If it is an AP connection, meaning the video conferencing accessory has no network at this point, so it's necessary to connect to the hot spot of the video conferencing host according to the parsed AP configuration before establishing the TCP network connection between them according to the IP address of the video conferencing host, thereby automatically recovering the pairing and linkage with the original video conferencing host. The present application can flexibly choose an appropriate connection method to connect with the video conferencing host based on the different network topologies of the video conferencing accessory, thereby increasing the success rate of restoring linkage.

Furthermore, the process of parsing an IP address, a MAC address, and an AP configuration of a video conferencing host when network information of the video conferencing host is identified in a broadcast message further includes:
not pairing with a non-video-conferencing-host device when network information of the non-video-conferencing-host device is identified in the broadcast message.

In the present application, in the process of searching for broadcast messages through Bluetooth, if other non-video-conferencing-host devices are identified, the identified network information will not be parsed, and the pairing with the non-video-conferencing-host device will not be performed, ensuring the security of device connections.

Furthermore, the process of determining the video conferencing host as the original video conferencing host when the parsed MAC address is the same as a saved MAC address of the original video conferencing host further includes:
keeping on the search through BLE when the parsed MAC address differs from the saved MAC address of the original video conferencing host until the network information of the original video conferencing host is identified.

In the present application, a comparison is made between the identified MAC address and the MAC address of the original video conferencing host saved in the video conferencing accessory. If they are the same, the BLE broadcast search is stopped. If they are different, the search continues until the network information of the original video conferencing host is identified, ensuring that the connected video conferencing host is the same video conferencing host before the disconnection, thereby enhancing connection accuracy.

Furthermore, the MAC address of the original video conferencing host is saved through a process comprising the following steps:
searching through BLE for a current network information of the original video conferencing host broadcasted by the original video conferencing host itself;
establishing a network topology with the original video conferencing host and pairing with the original video conferencing host based on the identified network information of the original video conferencing host;
saving the MAC address of the original video conferencing host after an initial pairing and linkage with the original video conferencing host.

In the present application, during the initial pairing of the video conferencing accessory and the video conferencing host, both of them need to enable BLE. The host broadcasts its network information through Bluetooth, and the accessory receives the host's network information through Bluetooth. Upon identifying the network information of the host to be connected, the accessory establishes a network topology with the host, successfully pairing them. Furthermore, the accessory saves the MAC address of the host, preventing the accessory and the host from being unable to retrieve the paired device in case of disconnection during the linkage between the host and the accessory. Saving the host's information in the accessory facilitates the quick retrieval of the original paired host.

Furthermore, the current network information of the original video conferencing host is broadcasted through a process comprising the following steps:
the original video conferencing host continuously broadcasts its current network information through BLE until a preset stop broadcasting condition is met or a preset maximum number of connected accessories is met.

In this application, as there may be a plurality of video conferencing accessories in the video conferencing system, the video conferencing host typically doesn't immediately stop broadcasting its network information after pairing with one accessory. Instead, it continues to broadcast until it reaches the user-set stop condition or the connected accessory count reaches the maximum supported connection limit. This ensures that a video conferencing host can connect to a plurality of video conferencing accessories, guaranteeing the normal operation of video conferencing.

Furthermore, the network topology with the original video conferencing host includes: direct wired connection, local area network connection, and AP connection.

In this application, the video conferencing host and accessories support a plurality of network topologies, including direct wired connection, local area network connection, and AP connection. This allows for a change in network topology to maintain the linkage between the video conferencing host and accessory if any one topology becomes unavailable, ensuring the normal operation of video conferencing.

In the present application, a method for automatically restoring linkage for a video conferencing system device is provided. In this method, after the video conferencing accessory loses connection with the video conferencing host, it can search for broadcast messages through the BLE of the video conferencing accessory, parses the relevant network information of the video conferencing host when the network information of the video conferencing host is identified, and then compares the parsed MAC address with the MAC address of the original video conferencing host saved in the video conferencing accessory. If they are the same, the video conferencing accessory checks its current network topology. If it is a direct wired connection or a local area network connection, the video conferencing accessory can directly establish a TCP connection between them; if it is an AP connection, the video conferencing accessory needs to connect to the hot spot of the video conferencing host according to the AP configuration of the host before establishing the TCP connection between them, thereby restoring the linkage between the video conferencing accessory and the host. This enables the automatic and rapid restoration of paired connection without manual intervention when the video conferencing host and video conferencing accessory lose connection.

A second aspect of the present application provides an apparatus for automatically restoring linkage for a video conferencing system device, wherein the apparatus includes: a searching module, a parsing module, a determining module, a requesting module and a linkage module; wherein
the searching module is configured to initiate a search for a broadcast message through BLE after losing connection with an original video conferencing host;
the parsing module is configured to parse an IP address, a MAC address, and an AP configuration of a video conferencing host when network information of the video conferencing host is identified in a broadcast message;
the determining module is configured to determine the video conferencing host as the original video conferencing host when the parsed MAC address is the same as a saved MAC address of the original video conferencing host;
the requesting module is configured to send a TCP network connection request to the video conferencing host according to the parsed IP address of the video conferencing host;
the linkage module is configured to restore linkage with the original video conferencing host when the video conferencing host accepts the TCP network connection request of a video conferencing accessory.

Furthermore, the requesting module includes: a checking unit, a first requesting unit, and a second requesting unit; wherein the checking unit is configured to check a current network topology;
the first requesting unit is configured to send a TCP network connection request to the video conferencing host according to the parsed IP address of the video conferencing host if the current network topology is a direct wired connection or a local area network connection;
the second requesting unit is configured to automatically connect to a hot spot of the video conferencing host according to the parsed AP configuration of the video conferencing host, receive a network from the video conferencing host, and send a TCP network connection request to the video conferencing host according to the parsed IP address of the video conferencing host if the current network topology is an AP connection.

The present application provides an apparatus for automatically restoring linkage for a video conferencing system device. Based on the combination of modules, the apparatus enables the automatic and rapid restoration of a paired connection without manual intervention when the video conferencing host and the video conferencing accessory lose connection.

A third aspect of the present application provides a video conferencing system, wherein the system includes a video conferencing accessory and a video conferencing host;
the video conferencing accessory performs the method for automatically restoring linkage for a video conferencing system device as described above.

The present application provides a video conferencing system, wherein the system includes one or more video conferencing accessories and a video conferencing host. The video conferencing accessory performs the method for automatically restoring linkage for a video conferencing system device as described above, enabling the disconnected video conferencing accessory to re-pair with the original video conferencing host.

### BRIEF DESCRIPTION OF THE DRAWINGS

FIG. 1 is a schematic diagram of a flowchart illustrating a method for automatically restoring linkage for a video conferencing system device provided by an embodiment of the present application.

FIG. 2 is a schematic diagram illustrating a network topology provided by an embodiment of the present application.

FIG. 3 is a schematic diagram illustrating a network topology provided by another embodiment of the present application.

FIG. 4 is a schematic diagram illustrating a network topology provided by yet another embodiment of the present application.

FIG. 5 is a schematic diagram of a flowchart illustrating a method for automatically restoring linkage for a video conferencing system device provided by another embodiment of the present application.

FIG. 6 is a schematic structural diagram illustrating an apparatus for automatically restoring linkage for a video conferencing system device provided by an embodiment of the present application.

### DETAILED DESCRIPTION OF THE INVENTION

Now, in conjunction with the drawings in the embodiments of the present application, the technical solutions in the embodiments of the present invention will be described clearly and comprehensively. Clearly, the described embodiments are only part of the embodiments of the present application, not all of them. Based on the embodiments of the present invention, all other embodiments obtained by those skilled in the art without making creative efforts fall within the scope of protection of the present application.

In the description of the present application, it should be understood that the terms used in the present application are as follows.
1. Network topology: refers to a physical layout of various devices interconnected by transmission media, especially refers to a distribution of computers and how cables pass through them.

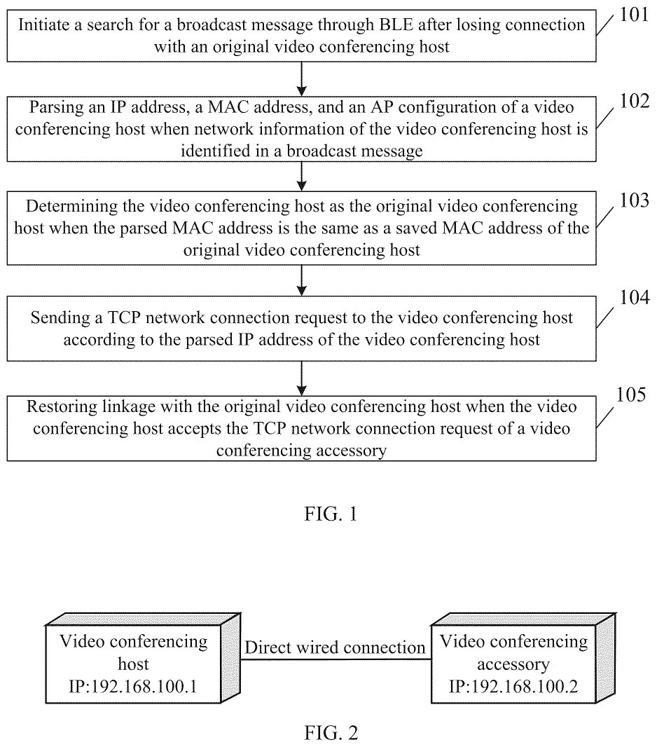

As shown in FIG. 1, it is a schematic diagram of a flowchart illustrating a method for automatically restoring linkage for a video conferencing system device provided by an embodiment of the present application. The method includes step 101 to step 105, and each step is specifically described as follows.

Step 101: initiating a search for a broadcast message through BLE after losing connection with an original video conferencing host.

In an embodiment of the present application, there are various reasons for the disconnection between the video conferencing accessory and the video conferencing host, such as a switch of the network topology between them, power outage of the accessory, or interruption of communication due to the accessory leaving the hot spot range during hot spot connection. Both the video conferencing host and the video conferencing accessory are equipped with a built-in Bluetooth module, supporting Bluetooth communication. The video conferencing host can broadcast its current network information, including IP address, MAC address, and AP configuration (containing information required for connecting to a hot spot) every 3 seconds through BLE.

Step 102: parsing an IP address, a MAC address, and an AP configuration of a video conferencing host when network information of the video conferencing host is identified in a broadcast message.

In an embodiment of the present application, the process of parsing an IP address, a MAC address, and an AP configuration of a video conferencing host when network information of the video conferencing host is identified in a broadcast message further includes:
not pairing with a non-video-conferencing-host device when network information of the non-video-conferencing-host device is identified in the broadcast message.

In an embodiment of present application, when the video conferencing accessory searches for broadcast messages through Bluetooth, it can not only identify information of the video conferencing host device but also identify information of other devices equipped with Bluetooth functionality. Since the video conferencing accessory reconnects with the video conferencing host automatically at this point, when other devices are identified, the video conferencing accessory will not parse the information of those devices. Instead, it continues the search for information of the video conferencing host, ensuring the correctness and security of device connections.

Step 103: determining the video conferencing host as the original video conferencing host when the parsed MAC address is the same as a saved MAC address of the original video conferencing host.

In an embodiment of the present application, the MAC address of the original video conferencing host is saved through a process comprising the following steps:
searching through BLE for a current network information of the original video conferencing host broadcasted by the original video conferencing host itself;
establishing a network topology with the original video conferencing host and pairing with the original video conferencing host based on the identified network information of the original video conferencing host;
saving the MAC address of the original video conferencing host after an initial pairing and linkage with the original video conferencing host.

In an embodiment of the present application, during the initial pairing of the video conferencing accessory and the video conferencing host, both of them need to enable BLE. The host broadcasts its network information through Bluetooth every 3 seconds. The accessory receives the host's network information through Bluetooth. Upon identifying the network information of the host to be connected, the accessory establishes a network topology with the host, successfully pairing them. Furthermore, the accessory saves the MAC address of the host, preventing the accessory and the host from being unable to retrieve the paired device in case of disconnection during the collaboration between them. Saving the host's information in the accessory facilitates the quick retrieval of the original paired host.

In an embodiment of the present application, the current network information of the original video conferencing host is broadcasted through a process comprising the following steps:
the original video conferencing host continuously broadcasts its current network information through BLE until a preset stop broadcasting condition is met or a preset maximum number of connected accessories is met.

In an embodiment of the present application, as there may be a plurality of video conferencing accessories in the video conferencing system, the video conferencing host typically doesn't immediately stop broadcasting its network information after pairing with one accessory. Users can set stop conditions on the video conferencing host to stop Bluetooth broadcasting or set a maximum connection limit to ensure that the video conferencing host will only stop broadcasting when it reaches the user-set stop condition or the connected accessory count reaches the maximum supported connection limit, ensuring that a video conferencing host can connect to a plurality of accessories and guaranteeing the normal operation of video conference.

In an embodiment of the present application, the network topology with the original video conferencing host includes: direct wired connection, local area network connection, and AP connection.

In an embodiment of present application, the video conferencing host and accessory support a plurality of network topologies, including direct wired connection, local area network connection, and AP connection. This allows for a change in network topology to maintain the linkage between the video conferencing host and accessory if any one topology becomes unavailable, ensuring the normal operation of video conferencing.

As an example in the present application, as shown in FIG. 2, it is a schematic diagram illustrating a network topology provided by an embodiment of the present application. The network topology between the video conferencing host and accessory may be a direct wired connection. The video conferencing accessory is connected directly to the network interface of the video conferencing host through an network cable. The video conferencing system host establishes a local private network and assigns an IP address to each directly connected accessory. For example, the host uses the address 192.168.100.1, and the accessory uses the address 192.168.100.2.

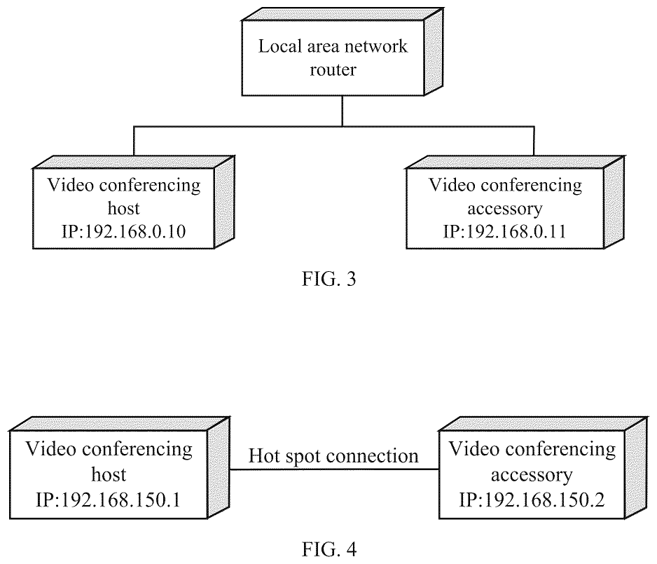

As an example in the present application, as shown in FIG. 3, it is a schematic diagram illustrating a network topology provided by another embodiment of the present application. The network topology between the video conferencing host and accessory may be a local area network connection, where both the video conferencing host and the video conferencing accessory are connected to the same local area network. This local area network can be either a wired local area network or a wireless local area network, with the devices being assigned IP addresses through a local area network router. For example, the host uses the address 192.168.0.10, and the accessory uses the address 192.168.0.11.

As an example in the present application, as shown in FIG. 4, it is a schematic diagram illustrating a network topology provided by yet another embodiment of the present application. The network topology between the video conferencing host and accessory may be an AP connection. The video conferencing host activates a wireless hot spot, and the video conferencing accessory connects to the video conferencing host via Wi-Fi (Wireless Fidelity). For example, the host uses the address 192.168.105.1, and the accessory address 192.168.150.2.

In an embodiment of the present application, the process of determining the video conferencing host as the original video conferencing host when the parsed MAC address is the same as a saved MAC address of the original video conferencing host further includes:
keeping on the search through BLE when the parsed MAC address differs from the saved MAC address of the original video conferencing host until the network information of the original video conferencing host is identified.

In an embodiment of the present application, when the video conferencing accessory identifies the network information of the video conferencing host, it parses this network information, makes a comparison between the identified and parsed MAC address and the MAC address of the original video conferencing host saved in the video conferencing accessory. If they are the same, the search for broadcasts through BLE is stopped. If they are different, the search continues until the network information of the original video conferencing host is identified, ensuring that the connected video conferencing host is the same video conferencing host before the disconnection, thereby enhancing connection accuracy.

Step 104: sending a TCP network connection request to the video conferencing host according to the parsed IP address of the video conferencing host.

In an embodiment of the present application, the process of sending a TCP network connection request to the video conferencing host according to the parsed IP address of the video conferencing host specifically includes:
checking a current network topology;
if the current network topology is a direct wired connection or a local area network connection, sending a TCP network connection request to the video conferencing host according to the parsed IP address of the video conferencing host;
if the current network topology is an AP connection, automatically connecting to a hot spot of the video conferencing host according to the parsed AP configuration of the video conferencing host, receiving a network from the video conferencing host, and sending a TCP network connection request to the video conferencing host according to the parsed IP address of the video conferencing host.

In an embodiment of the present application, when the network information of the original video conferencing host is identified, the video conferencing accessory needs to check the current network topology of the video conferencing accessory. If it is a direct wired connection or a local area network connection, the video conferencing accessory can directly establish the TCP network connection between them according to the parsed IP address of the video conferencing host. If it is an AP connection, meaning the video conferencing accessory has no network at this point, so it's necessary to connect to the hot spot of the video conferencing host according to the parsed AP configuration before establishing the TCP network connection between them according to the parsed IP address of the video conferencing host, thereby automatically recovering the pairing and linkage with the original video conferencing host. As the IP address changes after the disconnection between the video conferencing host and the video conferencing accessory, the re-connection is established based on the identified IP address of the video conferencing host. The present application can flexibly choose an appropriate connection method to connect with the video conferencing host based on the different network topologies of the video conferencing accessory, thereby increasing the success rate of restoring linkage.

Step 105: restoring linkage with the original video conferencing host when the video conferencing host accepts the TCP network connection request of a video conferencing accessory.

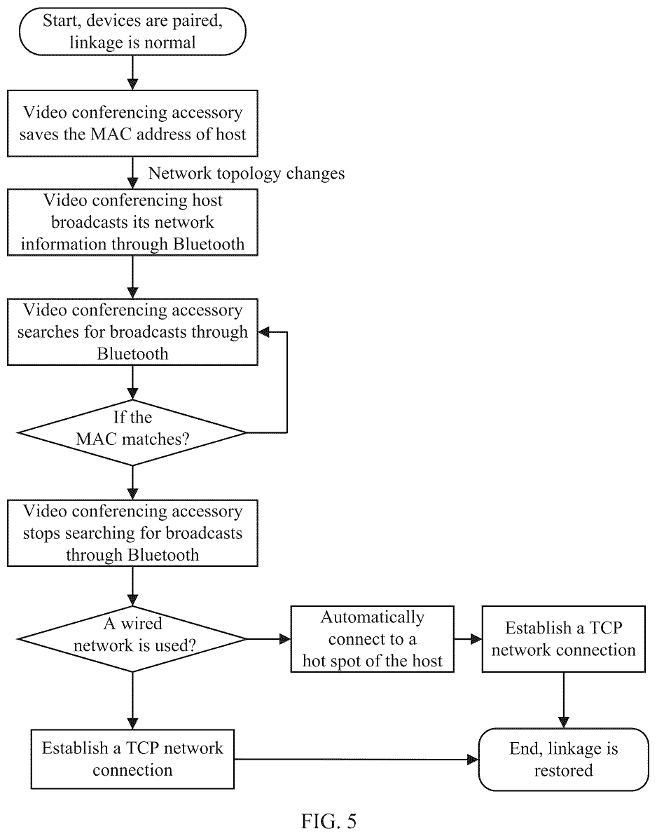

As an example of the embodiment of the present application, as shown in FIG. 5, it is a schematic diagram of a flowchart illustrating a method for automatically restoring linkage for a video conferencing system device according to another embodiment of the present application. After the video conferencing accessory initially paired with the video conferencing host, it can establish linkage normally and save the MAC address of the video conferencing host in the video conferencing accessory. When the video conferencing host and accessory lose connection due to changes in the network topology or other reasons, the video conferencing host will broadcast network information through Bluetooth. The video conferencing accessory searches for broadcast information through Bluetooth and upon identifying the network information of the video conferencing host, it compares the identified MAC address with the MAC address saved in the video conferencing accessory. If they are the same, the video conferencing accessory stops the search for broadcasts through Bluetooth, and checks the current network topology. If the current network topology is a direct wired connection or a local area network connection, it indicates that the accessory is using a wired network and can directly establish a TCP network connection with the host. If it's an AP connection, it indicates that the accessory has no network at this point and needs to connect to the host's hot spot before establishing a TCP network connection, thereby restoring the linkage.

The present application provides a method for automatically restoring linkage for a video conferencing system device. In this method, after the video conferencing accessory loses connection with the video conferencing host, the video conferencing accessory can search for broadcast messages through the BLE of the video conferencing accessory, parses the relevant network information of the video conferencing host when the network information of the video conferencing host is identified, and compares the parsed MAC address with the MAC address of the original video conferencing host saved in the video conferencing accessory. If they are the same, the video conferencing accessory checks its current network topology. If it is a direct wired connection or a local area network connection, a TCP connection can be directly established between them; if it is an AP connection, the accessory needs to connect to the hot spot of the video conferencing host according to the AP configuration of the host before establishing the TCP connection between them, thereby restoring the linkage between the video conferencing accessory and the host. This enables the automatic and rapid restoration of the paired connection without manual intervention when the video conferencing host and video conferencing accessory lose connection.

A second aspect of the present application provides an apparatus for automatically restoring linkage for a video conferencing system device. The apparatus includes a processor, a memory, and a computer program stored in the memory and executable on the processor. When the processor executes the computer program, it implements the steps of the method for automatically restoring linkage for a video conferencing system device of an embodiment described above, such as the steps 101 to 105 illustrated in FIG. 1.

As an example, the computer program can be divided into one or more modules, and these one or more modules are stored in the memory and executed by the processor to implement the present application. The one or more modules can be a series of computer program instruction segments capable of performing specific functions. For example, the computer program may be divided into a searching module 201, a parsing module 202, a determining module 203, a requesting module 204 and a linkage module 205. The specific functions of each module are as follows:
the searching module 201 is configured to initiate a search for a broadcast message through BLE after losing connection with an original video conferencing host;
the parsing module 202 is configured to parse an IP address, a MAC address, and an AP configuration of a video conferencing host when network information of the video conferencing host is identified in a broadcast message;
the determining module 203 is configured to determine the video conferencing host as the original video conferencing host when the parsed MAC address is the same as a saved MAC address of the original video conferencing host;
the requesting module 204 is configured to send a TCP network connection request to the video conferencing host according to the parsed IP address of the video conferencing host;
the linkage module 205 is configured to restore linkage with the original video conferencing host when the video conferencing host accepts the TCP network connection request of a video conferencing accessory.

In an embodiment of the present application, the requesting module 204 includes: a checking unit, a first requesting unit, and a second requesting unit; wherein the checking unit is configured to check a current network topology;
the first requesting unit is configured to send a TCP network connection request to the video conferencing host according to the parsed IP address of the video conferencing host if the current network topology is a direct wired connection or a local area network connection;
the second requesting unit is configured to automatically connect to a hot spot of the video conferencing host according to the parsed AP configuration of the video conferencing host, receive a network from the video conferencing host, and send a TCP network connection request to the video conferencing host according to the parsed IP address of the video conferencing host if the current network topology is an AP connection.

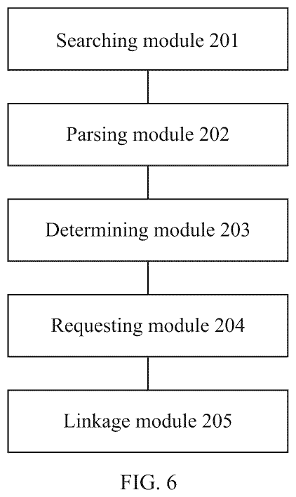

Those skilled in the art would understand that FIG. 6 is only an example and does not limit the present application. The apparatus for automatically restoring linkage of a video conferencing system device of the present application may include more or fewer components than illustrated, or may combine certain components, or may include different components. For example, the apparatus for automatically restoring linkage of a video conferencing system device may further include an input-and-output device, a network access device, a bus, etc.

A third aspect of the present application provides a video conferencing system, wherein the system includes: a video conferencing accessory and a video conferencing host;
the video conferencing accessory performs the method for automatically restoring linkage for a video conferencing system device as described in the first aspect and any embodiment of the first aspect.

In sum, the embodiments of the present application provide a method and an apparatus for automatically restoring linkage for a video conferencing system device. After the accessory loses connection with the host, it can search for broadcast messages through the BLE of the video conferencing accessory, parses the relevant network information of the video conferencing host when the network information of the video conferencing host is identified, and then compares the parsed MAC address with the MAC address of the original video conferencing host saved in the video conferencing accessory. If they are the same, the video conferencing accessory checks its network topology at this point. If it is a direct wired connection or a local area network connection, a TCP connection can be directly established between them; if it is an AP connection, the accessory needs to connect to the hot spot of the video conferencing host according to the AP configuration of the host before establishing the TCP connection between them, thereby restoring the linkage between the video conferencing accessory and the host. This enables the automatic and rapid restoration of the paired connection without manual intervention when the video conferencing host and the video conferencing accessory lose connection.

The specific embodiments described above provide further detailed explanations of the purpose, technical solutions, and beneficial effects of the present application. It should be understood that the above descriptions are only specific embodiments of the present application and are not intended to limit the scope of the present application. It is worth noting that for those skilled in the art, any modifications, equivalent substitutions, improvements, etc., made within the spirit and principles of the present invention should be included within the scope of protection of the present application.

1. A method for automatically restoring linkage for a video conferencing system device, wherein the method comprises:
initiating a search for a broadcast message through BLE after losing connection with an original video conferencing host;
parsing an IP address, a MAC address, and an AP configuration of a video conferencing host when network information of the video conferencing host is identified in a broadcast message;
determining the video conferencing host as the original video conferencing host when the parsed MAC address is the same as a saved MAC address of the original video conferencing host;
sending a TCP network connection request to the video conferencing host according to the parsed IP address of the video conferencing host;
restoring linkage with the original video conferencing host when the video conferencing host accepts the TCP network connection request of a video conferencing accessory.

2. The method for automatically restoring linkage for a video conferencing system device as claimed in claim 1, wherein the process of sending a TCP network connection request to the video conferencing host according to the parsed IP address of the video conferencing host specifically comprises:
checking a current network topology;
if the current network topology is a direct wired connection or a local area network connection, sending a TCP network connection request to the video conferencing host according to the parsed IP address of the video conferencing host;
if the current network topology is an AP connection, automatically connecting to a hot spot of the video conferencing host according to the parsed AP configuration of the video conferencing host, receiving a network from the video conferencing host, and sending a TCP network connection request to the video conferencing host according to the parsed IP address of the video conferencing host.

3. The method for automatically restoring linkage for a video conferencing system device as claimed in claim 1, wherein the process of parsing an IP address, a MAC address, and an AP configuration of a video conferencing host when network information of the video conferencing host is identified in a broadcast message further comprises:
not pairing with a non-video-conferencing-host device when network information of the non-video-conferencing-host device is identified in the broadcast message.

4. The method for automatically restoring linkage for a video conferencing system device as claimed in claim 1, wherein the process of determining the video conferencing host as the original video conferencing host when the parsed MAC address is the same as a saved MAC address of the original video conferencing host further comprises:
keeping on the search through BLE when the parsed MAC address differs from the saved MAC address of the original video conferencing host until the network information of the original video conferencing host is identified.

5. The method for automatically restoring linkage for a video conferencing system device as claimed in claim 1, wherein the MAC address of the original video conferencing host is saved through a process comprising the following steps:
searching through BLE for a current network information of the original video conferencing host broadcasted by the original video conferencing host itself;
establishing a network topology with the original video conferencing host and pairing with the original video conferencing host based on the identified network information of the original video conferencing host;
saving the MAC address of the original video conferencing host after an initial pairing and linkage with the original video conferencing host.

6. The method for automatically restoring linkage for a video conferencing system device as claimed in claim 5, wherein the current network information of the original video conferencing host is broadcasted through a process comprising the following steps:
the original video conferencing host continuously broadcasts its current network information through BLE until a preset stop broadcasting condition is met or a preset maximum number of connected accessories is met.

7. The method for automatically restoring linkage for a video conferencing system device as claimed in claim 5, wherein the network topology with the original video conferencing host comprises: direct wired connection, local area network connection, and AP connection.

8. An apparatus for automatically restoring linkage for a video conferencing system device, wherein the apparatus comprises: a searching module, a parsing module, a determining module, a requesting module and a linkage module; wherein
the searching module is configured to initiate a search for a broadcast message through BLE after losing connection with an original video conferencing host;
the parsing module is configured to parse an IP address, a MAC address, and an AP configuration of a video conferencing host when network information of the video conferencing host is identified in a broadcast message;
the determining module is configured to determine the video conferencing host as the original video conferencing host when the parsed MAC address is the same as a saved MAC address of the original video conferencing host;
the requesting module is configured to send a TCP network connection request to the video conferencing host according to the parsed IP address of the video conferencing host;
the linkage module is configured to restore linkage with the original video conferencing host when the video conferencing host accepts the TCP network connection request of a video conferencing accessory.

9. The apparatus for automatically restoring linkage for a video conferencing system device as claimed in claim 8, wherein the requesting module comprises: a checking unit, a first requesting unit, and a second requesting unit; wherein
the checking unit is configured to check a current network topology;
the first requesting unit is configured to send a TCP network connection request to the video conferencing host according to the parsed IP address of the video conferencing host if the current network topology is a direct wired connection or a local area network connection;
the second requesting unit is configured to automatically connect to a hot spot of the video conferencing host according to the parsed AP configuration of the video conferencing host, receive a network from the video conferencing host, and send a TCP network connection request to the video conferencing host according to the parsed IP address of the video conferencing host if the current network topology is an AP connection.

10. A video conferencing system, wherein the system comprises a video conferencing accessory and a video conferencing host;
the video conferencing accessory performs the method for automatically restoring linkage for a video conferencing system device as claimed in claim 1.
